(19) United States
(12) Patent Application Publication
(10) Pub. No.: US 2025/0236059 A1
(43) Pub. Date: Jul. 24, 2025

(54) EXTRUDER SCREW AND PROCEDURE TO MANUFACTURE THE SAME

(71) Applicant: Extruder Experts GmbH & Co. KG, Monschau (DE)

(72) Inventor: DIRK ZIMMERMANN, Monschau (DE)

(21) Appl. No.: 18/981,776

(22) Filed: Dec. 16, 2024

(30) Foreign Application Priority Data
Jan. 24, 2024 (DE) 102024101964.6

(51) Int. Cl. B29C 48/505

(52) U.S. Cl. CPC B29C 48/507

(57) ABSTRACT

An extruder screw including an elongated cylindrical tension rod; screw segments including radially protruding functional elements configured to feed, mix, and/or knead an extrudate, and a respective pass through bore hole oriented in a longitudinal direction of the extruder screw, wherein the screw segments are slid onto the tension rod with the pass through bore hole and axially supported at a tip of the tension rod; a counter element that clamps the screw segments against the tip of the tension rod at an end of the tension rod wherein the end is arranged distal from the tip; and a locking element that is clamped between the screw segments and the counter element.

### RELATED APPLICATIONS

This application claims priority from German patent application DE 10 2024 101 964.6 filed on Jan. 24, 2024, which is incorporated in its entirety by this reference.

### FIELD OF THE INVENTION

The invention relates to an extruder. The invention also relates to a method for producing an extruder screw.

### BACKGROUND OF THE INVENTION

DE 10 2021 112 163 A1 proposes to support the preassembled extruder screw in a clamping device in order to clamp the screw segments and to pull the end of the tension rod against the tip out of the screw segments with a defined force, to tighten a clamping nut hand tight that is applied to a fine pitch thread at an end of the tension rod as a counter element, and to relieve the load from the tension rod again thereafter.

### BRIEF SUMMARY OF THE INVENTION

Thus it is an object of the invention to simplify clamping of the screw elements.

The object is achieved by ann extruder screw including an elongated cylindrical tension rod; screw segments including radially protruding functional elements configured to feed, mix, and/or knead an extrudate, and a respective pass through bore hole oriented in a longitudinal direction of the extruder screw, wherein the screw segments are slid onto the tension rod with the pass through bore hole and axially supported at a tip of the tension rod; a counter element that clamps the screw segments against the tip of the tension rod at an end of the tension rod wherein the end is arranged distal from the tip; and a locking element that is clamped between the screw segments and the counter element.

Improving upon a known extruder screw it is proposed according to the invention that a locking element is clamped between the screw segments and the counter element.

The locking element maintains the tension of the tension rod without tightening the counter element. Rotating the counter element about the longitudinal direction at the tension rod is not required for clamping the screw segments of the extruder screw according to the invention. Additionally, a length of the locking element directly determines the compression in the screw elements and the tension in the tension rod and the lengthening or compression of the elements of the extruder screw. An overload due to excessive tightening of the counter element is thus more easily avoidable by design compared to known extruder screws and an insufficiently low tension that could compromise the function of the extruder screw is easily avoidable as well.

Advantageously, the locking element of the extruder screw according to the invention envelops the tension rod as an annular shape. The annular shape facilitates an even force introduction from the counter element into the screw segments along a circumference of the tension rod. Thus, the locking element can be made from two or more partial rings which form the locking element by being mounted between the counter element and the screw segments.

A clamping nut is advantageously threaded as a counter element onto a thread at an end of the tension rod of the extruder screw according to the invention. The counter element can then be easily tightened by hand at an end of the preassembly in that the screw elements contact the tip and each other and the counter element contacts the last screw element. The thread can be in particular a fine thread or a self-locking trapezoid thread.

Since the counter element according to the invention does not have to be freely rotatable at the tension rod about the longitudinal direction in order to clamp the screw elements like in the extruder screw known from DE 10 2021 112 163 A1. The clamping device can directly contact the counter element. In particular, the clamping device can contact the thread when the thread penetrates the counter element in the longitudinal direction.

Advantageously, the extruder screw according to the invention includes a drive segment with an outer spline that fits into a drive hub of an extruder as the last screw segment at an end of the tension rod. Drive segments of this generic type are well known and well proven in the art. Advantageously, also the counter element of an extruder screw according to the invention includes the spline. A rotation of the counter element about the longitudinal axis is thus effectively prevented alternatively or in addition to the thread being self-locking.

Extruder screws according to the invention are used in single extruders, double extruders, or multi-extruders co-rotating and counter-rotating. Extruders of this type are well known and well proven in the art.

Improving upon the known method, it is proposed according to the invention that the tension rod is pulled against the tip and out of the screw segments in order to clamp the screw segments and then a locking element is inserted between the screw segments and the counter element and the tension rod is eventually clamped so that the locking element is clamped between the screw segments and the counter element. The extruder screw according to the invention is produced by the method according to the invention. The method according to the invention is characterized by the same advantages that characterize the extruder screw according to the invention.

Advantageously, the tension rod is pulled at the counter element out of the screw segments according to the method according to the invention. Thus, the tension rod is not weakened by a dead hole which differs from the known extruder screw according to the DE 10 2021 112 163 A1.

Advantageously, a cylindrical coupling piece is slid onto the tension rod respectively between the screw segments according to a method according to the invention, wherein the cylindrical coupling piece connects the screw segments torque proof. A torque proof connection is provided in particular when the screw segments have a fitted cross section on an inside and the coupling pieces have a cooperating fitted cross section on an outside so that the screw segments and the coupling pieces are connected torque proof about the longitudinal direction. The fitted cross section can be a longitudinally oriented spline on an outside of the coupling pieces and on an inside of the pass through bore hole, in particular extending over an entire length of the pass through bore hole. The spline is a longitudinal tooth work on a cylindrical surface, wherein the two flanks run parallel to the cylinder axis and transfer the torque between the shaft and the hub. Standard splines with involute, wedge flanks and notch flanks are producible in a particularly economical manner.

Advantageously, the counter element includes the spline of the drive segment when performing the method according to the invention. The counter element is thus mechanically secured by a corresponding internal teething of the drive during operation of the extruder screw.

Advantageously, the tension rod is hydraulically lengthened when performing the method according to the invention. Hydraulic press cylinders are available economically and in great variety

### BRIEF DESCRIPTION OF THE DRAWINGS

The invention is subsequently described based on advantageous embodiment with reference to drawing figures, wherein;

FIG. 1 illustrates an extruder according to the invention; and

FIGS. 2A, 2B, 2C illustrate three steps of the method according to the invention.

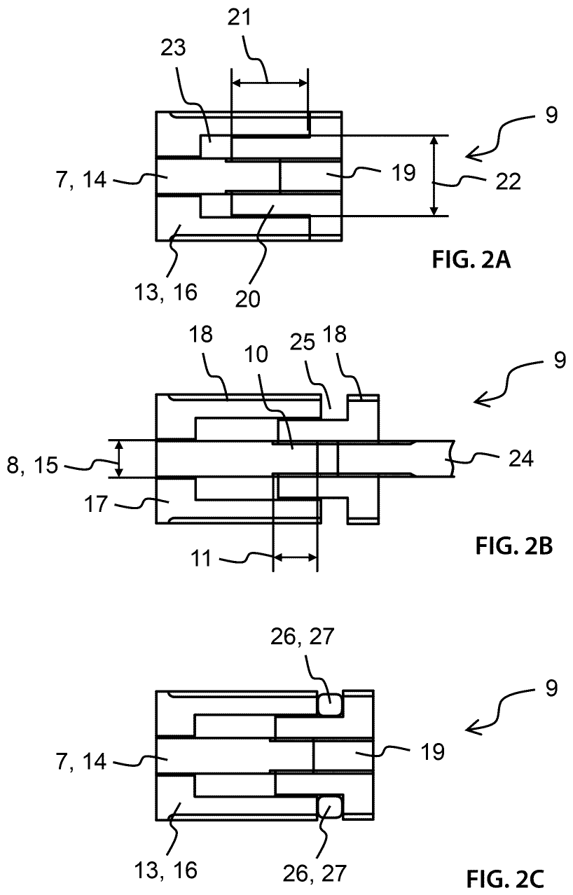

### DETAILED DESCRIPTION

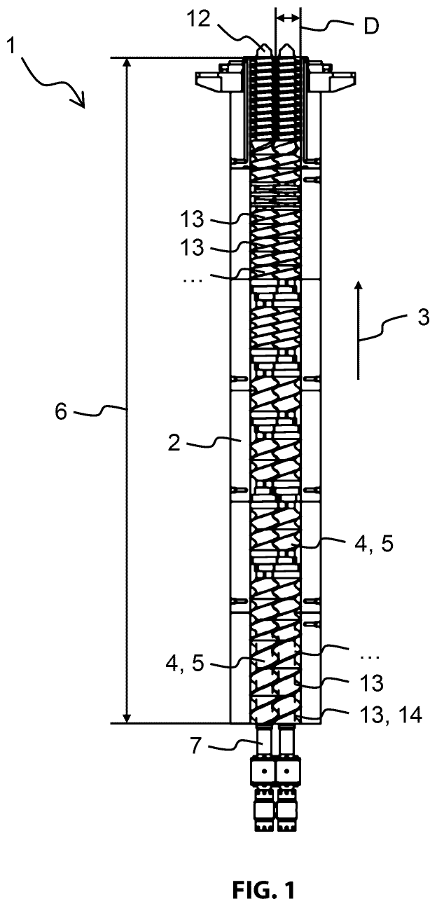

The extruder 1 shown in FIG. 1, thus a twin shaft extruder, includes a housing 2 including an operating space 4 extending in a longitudinal direction 3, wherein the operating space has a cross section shaped as a lazy 8 including two extruder screws 5 with a diameter D of 60 mm and a process length 6 of 240 cm, thus 40 D wherein the extruder screws are supported rotatable in identical directions.

The extruder screws 5 according to the invention include a tension rod 7. The tension rod 7 is made from tempered steel and has a diameter 8 of 16.5 mm and includes a fine thread 10 (M16×0.5) with a length 11 of 25 mm respectively at a front end and a back end 9.

In order to produce an extruder screw 5, a tip 12 is initially threaded onto the front end. Approximately 40 screw segments 13 are supported at the tip 12 and include a radially protruding functional element configured to feed, mix, and/or knead an extrudate in the extruder 1, and eventually a drive segment 16 configured as a last of the screw segments 13 is slid onto the tension rod 7.

The screw segments 13 include a pass through bore hole 14 with an inner diameter 15 of 16.5 mm for the tension rod 8 with a spline according to DIN 5480 with an inner tip diameter of 29.5 mm, an outer tip diameter of 32 mm and 24 teeth with notch flanks. Cylindrical coupling pieces with the corresponding outer splines are slid onto the tension rod in an alternating manner with the screw segments 13 wherein the cylindrical coupling pieces connect respectively adjacent screw segments 13 with one another torque proof. The coupling pieces are not shown in detail.

Another extruder according to the invention includes a hollow shaft with longitudinal teething configured as the tension rod instead of the coupling pieces known from DE 10 2021 112 163 A1. Hollow shafts of this type are well known in the art.

The drive segment 16 includes a tube 17 and an outer spline 18 adjoining the functional elements. The tube 17 and the tension rod 7 include a fit with a clearance.

A clamping nut with the outer spline 18 of the drive segment 16 is threaded as a counter element 19 onto a fine thread 10 at a rear end 9 of the tension rod 7, wherein the clamping nut is inserted into an axial bore hole 23 of the tube 17 with a shoulder 20 with a length 21 of 28 mm and a diameter 22 of 23 mm. The shoulder 20 and the bore hole 23 also include a fit with a clearance.

As a final step in the preassembly, an alignment sleeve is slid with the spline 18 over the counter element 19 and the drive segment 16 wherein the alignment sleeve prevents an unintentional rotation of the counter element 19 relative to the drive segment 16.

In order to clamp the tension rod 7 the screw elements of the extruder screw 5 are supported in a clamping device, a tension rod 24 of the clamping device is threaded into the fine thread 10 of the counter element 19 and pulled out of the extruder screw 5 by a hydraulic hollow piston cylinder with a force of 40 kN. The clamping device is not illustrated beyond the tension rod 24.

The alignment sleeve is slid far enough onto the drive segment 16 in the clamped position so that the clamping nut renders the intermediary space 25 towards the counter element 19 accessible. Then two half rings 26 are inserted into the intermediary space 25 wherein the two half rings form a locking element 27 that envelops the tension rod 7 in an annular shape. As a last step the tension rod 7 is unloaded and the clamping device is dismounted.

When maintaining the extruder screw 5 after a predetermined service life, the tension of the tension rod 7 can be readjusted in the same way. When the extruder screw 5 is damaged or worn during operations, it can be disassembled easily in order to replace individual screw segments.

### REFERENCE NUMERALS AND DESIGNATIONS

1 extruder
2 housing
3 longitudinal direction
4 operating space
5 extruder screw
D diameter
6 process length
7 tension rod
8 diameter of tension rod
9 end
10 thread
11 length of thread
12 tip
13 screw segment
14 pass through bore hole
15 inner diameter of tube
16 drive segment
17 tube
18 spline
19 counter element
20 shoulder
21 length of spout
22 diameter of spout
23 bore hole
24 tension rod
25 intermediary space
26 half-ring
27 locking element

What is claimed is:

1. An extruder screw, comprising:
an elongated cylindrical tension rod;
screw segments including radially protruding functional elements configured to feed, mix, and/or knead an extrudate, and a respective pass through bore hole oriented in a longitudinal direction of the extruder screw, wherein the screw segments are slid onto the tension rod with the pass through bore hole and axially supported at a tip of the tension rod;
a counter element that clamps the screw segments against the tip of the tension rod at an end of the tension rod wherein the end is arranged distal from the tip; and
a locking element that is clamped between the screw segments and the counter element.

2. The extruder screw according to claim 1, wherein the locking element envelops the tension rod in an annular shape.

3. The extruder screw according to claim 1, further comprising: a thread arranged at the end of the tension rod, wherein a clamping nut is threaded onto the thread as the counter element.

4. The extruder screw according to claim 1, further comprising: a drive element including an outer spline and configured as a last screw segment at the end of the tension rod, wherein the spline is complementary to a drive hub of an extruder.

5. The extruder screw according to claim 4, wherein the counter element also includes the outer spline.

6. An extruder including at least one extruder screw according to claim 1.

7. A method for producing an extruder screw, the method comprising:
sequentially sliding screw segments including radially protruding functional elements configured to feed, mix, and/or knead an extrudate and including a pass through bore hole in a longitudinal direction of the extruder screw with the pass through bore hole onto an elongated cylindrical tension rod;
axially supporting the screw segments at a tip of the tension rod; and
clamping the screw segments against the tip at an end of the tension rod arranged distal from the tip using a counter element;
pulling the tension rod out of the screw segments towards the tip for clamping the screw segments;
thereafter inserting a locking element between the screw segments and the counter element; and
eventually unloading the tension rod so that the locking element is clamped between the screw segments and the counter element.

8. The method according to claim 7, further comprising: pulling the tension rod out of the screw segments by the counter element.
